(19) United States
(12) Patent Application Publication
(10) Pub. No.: US 2002/0002817 A1
(43) Pub. Date: Jan. 10, 2002

(54) Pulse width modulated valve transition control logic

(76) Inventor: Timothy J. Keller, Albuquerque, NM (US)

Correspondence Address: Ephraim Starr, Honeywell Power Systems Inc., 8725 Pan American Fwy. NE, Albuquerque, NM, 87113, US

(21) Appl. No.: 09/898,649

(22) Filed: Jul. 3, 2001

Related U.S. Application Data
(60) Provisional application No. 60/215,803, filed on Jul. 5, 2000.

(51) Int. Cl. F02C 9/00; F02C 7/26; F02G 3/00

(52) U.S. Cl. 60/39.02; 60/39.06; 60/39.03

(57) ABSTRACT

A method of and software for transition control for a pulse width modulated valve operating at a variable frequency (such as those employed with turbine generators) comprising determining that a transition is to be made between valve frequencies and smoothly changing the valve frequency over a time period.

CROSS-REFERENCE TO RELATED APPLICATIONS

This application claims the benefit of the filing of U.S. Provisional Patent Application Ser. No. 60/215,803, entitled “Transition Control Logic”, filed on Jul. 5, 2000, and the specification thereof is incorporated herein by reference.

### SUMMARY OF THE INVENTION

The present invention is of a method of and software for transition control for a pulse width modulated valve operating at a variable frequency (such as employed with a turbine generator), comprising: determining that a transition is to be made between valve frequencies; and smoothly changing the valve frequency over a time period. In the preferred embodiment for use with a turbine generator, the invention avoids discontinuities in the fuel flow during the transition and concomitant blowouts when the turbine generator is operating in a lean pre-mix mode. Switch logic and a rate limiter are employed to generate the valve frequency output to the valve. A duty cycle is determined by employing pulse width modulation tables comprising entries for valve frequencies and corresponding desired duty cycles and interpolation transition logic for generating a single duty cycle value based on the corresponding desired duty cycles. Fuel flow can remain constant during the transition or be altered during the transition. The invention provides a forward instantaneous path between the valve flow command (such as a fuel flow command for a microturbine) and the pulse width modulation command.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating specific embodiments of the invention and are not to be construed as limiting the invention. In the drawings:

FIG. 1 is a transition control logic diagram according to an embodiment of the present invention;

FIG. 2 is a plot of a microturbine operating with a dual mode valve during transitions from high to low frequency, while speed control is maintained;

FIG. 3 is a plot of a detailed view of one of the high to low transitions from FIG. 2.

### DESCRIPTION OF THE INVENTION

A need to achieve low emissions using a lean premix combustor has placed stringent requirements on fuel controls, which need at least an approximately 100 to 1 turn down ratio, to reach low pilot fuel flows, and/or for achieving low light-off fuel flows. In lean premix, the total fuel flow required to run the engine is split between the pilot and premix portions of the combustor. The emissions are controlled scheduling a high amount of premix flow, and low amount of pilot flow. Using low-cost, “dog-servo” valves driven by proportional solenoids, it is difficult to flow less than the “lift off” flow in the normal mode of operation, and therefore, the low fuel flow for pilot can not easily be achieved, leading to higher emissions. Use of dual-mode control on the valve allows for lower flows; however, instantaneous switching between modes causes the combustor to blow-out.

In typical turbine generators, a pulse width modulated (PWM) valve operates at a fixed frequency and a variable duty cycle. According to one embodiment, the present invention is concerned with control logic to transition between frequencies while a turbine generator, e.g., a microturbine or “turbogenerator”, is operational. For example, at each frequency of a two-frequency valve, e.g., approximately 31 Hz and approximately 160 Hz, the valve has a corresponding PWM versus fuel flow characteristic, and therefore, a different control schedule in an ECU (engine control unit microprocessor-based) for each mode. Switching instantaneously between the frequencies, and the associated PWM tables, causes a discontinuity in the fuel flow and a blow-out when operating the combustor in a lean pre-mix mode. To avoid blow-out, there should be a slow transition from high to low frequency mode, without rate-limiting fuel flow command output, which would limit controllability during the transition.

According to an embodiment of the present invention, transition control logic allows for instantaneous fuel flow command to PWM (signal to fuel valve) conversion to maintain turbine speed control. This is optionally achieved in combination with a smooth transition between modes (both frequency and/or PWM output).

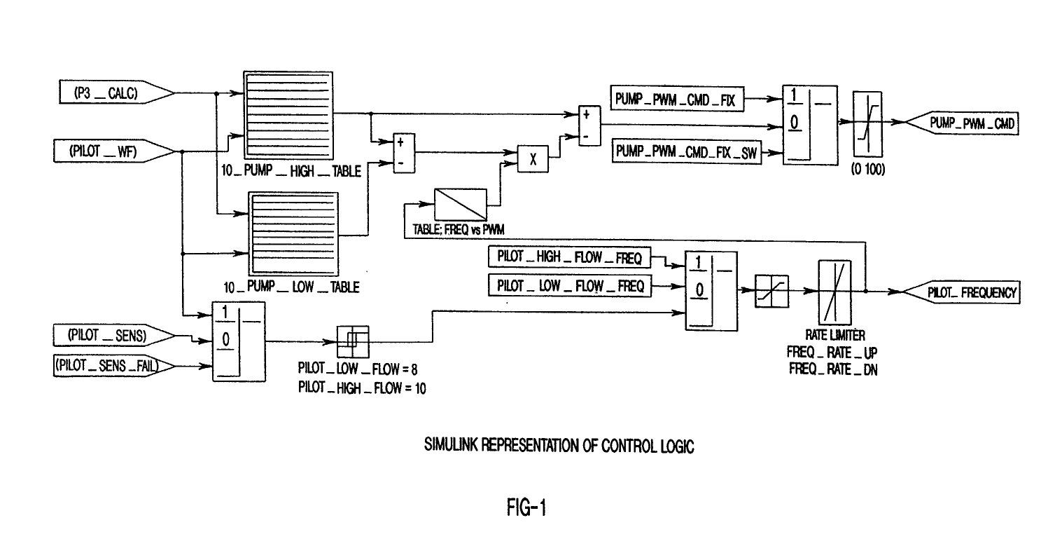

I/O pump tables, as shown in FIG. 1, are based on experiments and/or other data or characteristics to form a characteristic curve, table or an empirical fit. Of course, equations and/or curves and the like are also within the scope of the present invention. Thus, the present invention is not restricted to the use of tables.

In one embodiment, only the pilot portion of the pilot-pre-mix combustor switches from high to low frequency. The ECU schedules both the PWM output and the frequency. The switch is based on pilot fuel flow sensor feedback. When the pilot flow goes below a predetermined level, e.g., approximately 8 PPH, a mode switch is initiated. When the switch is initiated, the frequency command is rate limited to a transition between frequencies in a limited period of time, for example, a transition from approximately 160 Hz to approximately 31 Hz in approximately 1.5 seconds. According to this embodiment, as frequency is slewed, a real-time interpolation between a high, e.g., 160 Hz, PWM table and a low, e.g., 31 Hz, PWM table takes place. This interpolation provides the correct duty cycle for the corresponding frequency. This embodiment allows for the instantaneous conversion of a fuel flow command into a PWM command, while slewing between frequencies and corresponding PWM tables.

The invention also encompasses transitions in duty cycle, whether or not the fuel flow rate is to remain the same. Likewise for frequency, the fuel flow does not need to remain constant for all applications.

The present invention encompasses control logic and an inventive method of controlling a valve. Control includes, but is not limited to, transitioning from low to high and high to low frequency operation; of course, a valve may have more than two states. An embodiment of the present invention also uses duty cycle as a control variable. Duty cycle and frequency represent control variables that can be changed independently and/or in combination. An embodiment of the present invention optionally varies duty cycle in an overall range from 0% to 100%, in a continuous and/or discrete manner. Thus, in this embodiment duty cycle is variable between, for example, 0% and 0.1%, 0.99% and 100% and 10% and 20%, which are all within the 0% to 100% range. Of course, smaller ranges of variation are within the scope of the present invention.

According to an embodiment of the present invention, fuel flow optionally remains constant as frequency and/or duty cycle are changed. In another embodiment, fuel flow changes at the same time that frequency and/or duty cycle change. In this embodiment, fuel flow optionally changes to maintain some predetermined, simultaneously determined, and/or substantially simultaneously determined condition. For turbine generators, this condition includes, for example, but is not limited to, lean blow-out, rich blow-out, and/or other combustion conditions. In one embodiment, the invention allows for control of a valve from zero flow to, for example, a flow of approximately 8 lbs/h of fuel. In another embodiment, a secondary frequency is introduced to dither the valve, e.g., a higher frequency. Of course, a multitude of frequency inputs are within the scope of the present invention, as are a variety of pulse shapes.

In one embodiment, the present invention, as applied to fuel input to a turbine generator, allows for transitioning between two frequencies while maintaining a set fuel flow such that blow out does not occur. In turbine generators and/or other systems, the control is optionally aided by a theoretical model, physical parameters of the combustor, a learning system, etc. For example, CO and/or CO₂ concentration may be used directly and/or through a model and/or learning (or expert) system to signal the approach of an unstable operational condition.

The present invention is useful for many applications, basically wherever a fluid and/or gas is controlled by a valve or similar device. Fields of use include, but are not limited to, aircraft, hospitals (e.g., oxygen), biomedical (including implants), automobiles, etc.

Referring to FIG. 1, transition control logic is shown in a SIMULINK® (The MathWorks, Inc., Natick Mass.) format. SIMULINK® software provides an interactive tool for modeling, simulating, and analyzing dynamic systems. Commonly used in control system design, DSP (digital signal processor) design, communication system design, and other simulation applications, SIMULINK® software enables building of graphical block diagrams, simulation of dynamic systems, evaluation of system performance, and refinement of designs. Through its seamless integration to SIMULINK®, STATEFLOW® software provides event-handling simulation and supervisory logic.

FIG. 1 shows two control output signals, the PUMP_PWM_CMD (the desired duty cycle) and the PILOT_FREQUENCY (the frequency of the PWM output signal). The Tables IO_PUMP_HIGH_TABLE (for 160 Hz) and IO_PUMP_LOW_TABLE (for 31 Hz) perform the fuel flow to PMM conversion. The high frequency value is defined by PILOT_HIGH_FLOW_FREQ (160 Hz) and the low frequency value is defined by PILOT_LOW_FLOW_FREQ (31 Hz). The switch between the high to low frequency is initiated when the sensed pilot fuel flow (PILOT_SENS) drops below the hysteresis band (8 PPH). At that time, the input to the rate limiter switches from 160 to 31 instantaneously. The output of the rate limiter decreases at FREQ_RATE_DN (or up in the case of a low to high transition) equal to −87 Hz/s (+87 Hz/s). As the PILOT_FREQUENCY is slewing, the frequency is converted to a multiplier by the table Freq vs PWM. The multiplier sweeps between 1 and 0, where it is 1 at 31 Hz and 0 at 160 Hz, and varies linearly in between. This multiplier, together with the two summing junctions have the effect of linearly interpolating between the High and Low PWM tables in real time, as the frequency slews. While this linear interpolation is taking place, the instantaneous forward control path (PILOT_WF to PUMP_PWM_CMD) is maintained, while providing the correct PWM and Frequency pair.

### EXAMPLE

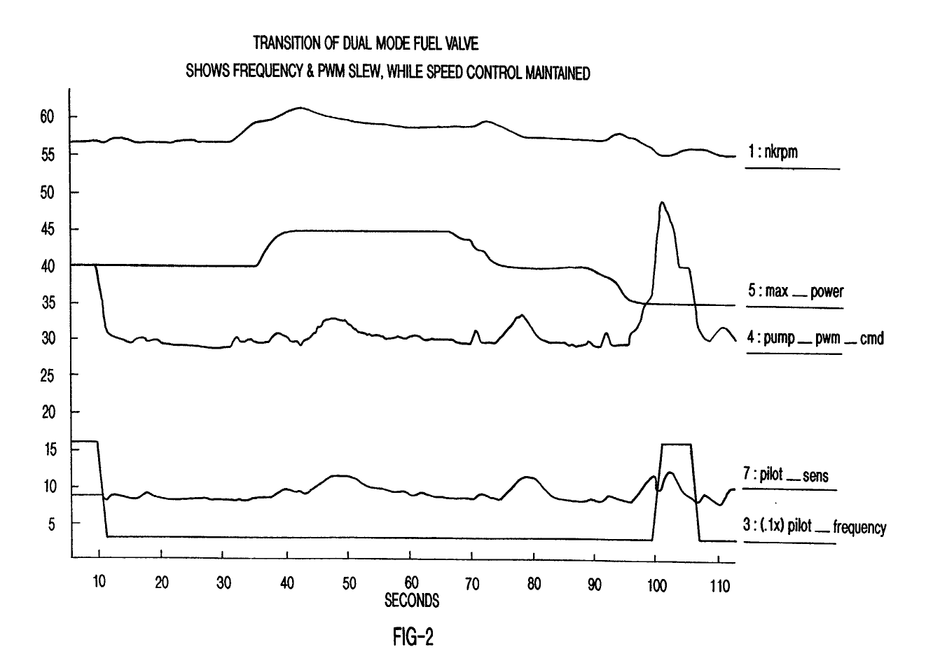

FIG. 2 shows engine speed (NKRPM), the pilot frequency divided by 10, the PWM duty cycle (PUMP_PWM_CMD), the power output (max_power), and the sensed pilot fuel flow (pilot_sens). At time=10 s, the pilot frequency transitioned from high to low (16 to 3.1 on the figure), due to the sensed fuel flow dropping below 8 PPH. As the frequency slewed, the duty cycle changed correspondingly (40 percent to 30 percent) while the power (40 KW) and speed (57 KRPM) are maintained. At 35 s, the power increased from 40 KW to 45 KW, and then at 65 s back down to 40 KW, all while the speed is maintained. At 100 s, the frequency made a low to high, and then a high to low transition based on the sensed fuel flow. Of course, predictive logic and/or other methods of triggering control may be implemented. For example, but not limited to, change in load, change in temperature, change in exhaust gas composition and/or flow, and transition into or out of a low emissions mode of operation. Control may be proactive.

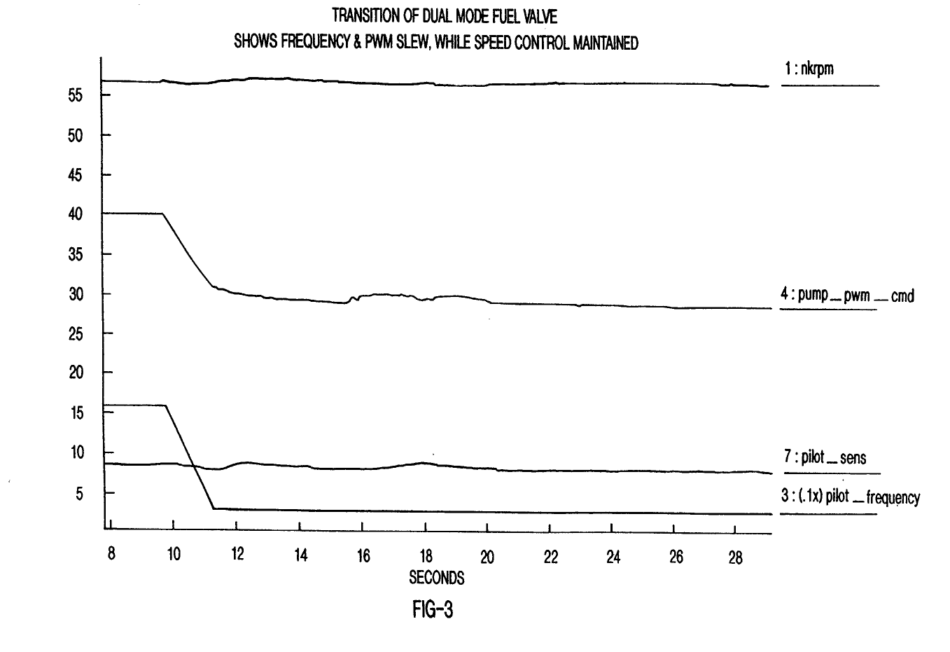

FIG. 3 shows the speed, pilot frequency divided by 10, the duty cycle and the sensed fuel flow. At approximately 10 s, the frequency and PWM transitioned over 1.5 seconds, while the speed and sensed fuel flow remained relatively constant.

Inventive control logic according to an embodiment of the present invention can be implemented on a microturbine for generating electrical power. The microturbine can be fitted with fuel valves capable of dual mode operation, such as dog-servo valves manufactured by the Automatic Switch Company (ASCO®, Florham Park, N.J.).

General Description of ASCO Valves

The ASCO valves are dog-servo valves, that is, there are two moving flow sections that are pneumatically coupled, the pilot (not to be confused with the pilot portion of the combustor and its associated fuel flow), and the main body. In this invention when the frequency is set to 31 Hz, the main body does not move, while the pilot opens and closes against its seat, creating a smaller effective orifice, and therefore lower flow. In the high frequency mode, both the pilot and the main body move, but are not able to respond fully to the higher frequency PWM command. In the high frequency mode, the moving parts “dither” to reduce friction, while in the low frequency mode the pilot actually strokes from opened to closed positions.

ASCO offers the world's largest selection of General Service 2, 3, and 4 way valves to handle virtually any application. ASCO valves are available in brass, stainless steel, plastic and aluminum. Diaphragms and seats come in a wide range of resilient materials. Enclosures are available to operate from −40° F. to 392° F. (−40° C. to 200° C.) in normal and hostile or explosive environments. General Service valves are available to control air, water, light oil and inert gas. Of course, other fluids and/or gases may be used depending on compatibility. Pipe sizes of 2 way solenoid valves are available from ⅛″ to 3″. Pipe sizes of 3-way solenoid valves range from ⅛″ to 1″. The pipe size range of 4 way solenoid valves is ⅛″ to 1″. Many optional features are available. The invention is not limited to ASCO valves.

The preceding examples can be repeated with similar success by substituting the generically or specifically described components, reactants and/or operating conditions of this invention for those used in the preceding examples.

Although the invention has been described in detail with particular reference to specific embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A method of transition control for a turbine generator comprising a pulse width modulated valve operating at a variable frequency, the method comprising the steps of:
determining that a transition is to be made between valve frequencies; and
smoothly changing the valve frequency over a time period.

2. The method of claim 1 wherein the method avoids discontinuities in the fuel flow during the transition and concomitant blow-outs when the turbine generator is operating in a lean pre-mix mode.

3. The method of claim 2 wherein fuel flow remains constant during the transition.

4. The method of claim 2 wherein fuel flow alters during the transition.

5. The method of claim 2 wherein the method provides a forward instantaneous path between a fuel flow command and a pulse width modulation command.

6. The method of claim 1 wherein the changing step comprises employing switch logic and a rate limiter to generate the valve frequency output to the valve.

7. The method of claim 1 additionally comprising the step of determining a duty cycle by employing pulse width modulation tables comprising entries for valve frequencies and corresponding desired duty cycles.

8. The method of claim 7 wherein the step of determining a duty cycle additionally comprises employing interpolation transition logic for generating a single duty cycle value based on the corresponding desired duty cycles.

9. A method of transition control for a pulse width modulated valve operating at a variable frequency, the method comprising the steps of:
determining that a transition is to be made between valve frequencies; and
smoothly changing the valve frequency over a time period.

10. The method of claim 9 wherein the changing step comprises employing switch logic and a rate limiter to generate the valve frequency output to the valve.

11. The method of claim 9 additionally comprising the step of determining a duty cycle by employing pulse width modulation tables comprising entries for valve frequencies and corresponding desired duty cycles.

12. The method of claim 11 wherein the step of determining a duty cycle additionally comprises employing interpolation transition logic for generating a single duty cycle value based on the corresponding desired duty cycles.

13. The method of claim 9 wherein flow through the valve remains constant during the transition.

14. The method of claim 9 wherein flow through the valve alters during the transition.

15. The method of claim 9 wherein the method provides a forward instantaneous path between a valve flow command and a pulse width modulation command.

16. Computer software for transition control for a turbine generator comprising a pulse width modulated valve operating at a variable frequency, the software comprising:
means for determining that a transition is to be made between valve frequencies; and
means for smoothly changing the valve frequency over a time period.

17. The software of claim 16 wherein the software avoids discontinuities in the fuel flow during the transition and concomitant blow-outs when the turbine generator is operating in a lean pre-mix mode.

18. The software of claim 16 wherein the changing means comprises switch logic and a rate limiter to generate the valve frequency output to the valve.

19. The software of claim 16 additionally comprising pulse width modulation tables comprising entries for valve frequencies and corresponding desired duty cycles.

20. The software of claim 19 additionally comprising interpolation transition logic for generating a single duty cycle value based on the corresponding desired duty cycles.

21. The software of claim 16 wherein the software provides a forward instantaneous path between a fuel flow command and a pulse width modulation command.

22. Computer software for transition control for a pulse width modulated valve operating at a variable frequency, the software comprising:
means for determining that a transition is to be made between valve frequencies; and
means for smoothly changing the valve frequency over a time period.

23. The software of claim 22 wherein the changing means comprises switch logic and a rate limiter to generate the valve frequency output to the valve.

24. The software of claim 22 additionally comprising pulse width modulation tables comprising entries for valve frequencies and corresponding desired duty cycles.

25. The software of claim 24 additionally comprising interpolation transition logic for generating a single duty cycle value based on the corresponding desired duty cycles.

26. The software of claim 22 wherein the software provides a forward instantaneous path between a valve flow command and a pulse width modulation command.
